(19) United States
(12) Patent Application Publication
(10) Pub. No.: US 2002/0056800 A1
(43) Pub. Date: May 16, 2002

(54) Precision bearing for feed modules of automatic placement machines

(76) Inventors: Thomas Liebeke, Kolbermoor (DE); Michael Schwiefert, Muenchen (DE)

Correspondence Address: STAAS & HALSEY LLP, 700 11TH STREET, NW, SUITE 500, WASHINGTON, DC, 20001, US

(21) Appl. No.: 09/912,402

(22) Filed: Jul. 26, 2001

(30) Foreign Application Priority Data
Nov. 3, 2000 (DE) 10054611.0

(51) Int. Cl. F16M 11/00

(52) U.S. Cl. 248/694

(57) ABSTRACT

In automatic placement machines having a forced guidance, feed modules are guided displaceably on the automatic placement machine in the longitudinal direction using a precision bearing in a manner exhibiting play, and also having a precision guidance separate therefrom, by which the feed modules can be positioned without play in an end region of the precision bearing.

### BACKGROUND OF THE INVENTION

1. Field of the Invention

The invention relates to a precision bearing for feed modules of automatic placement machines.

2. Description of the Related Art

On an automatic placement machine there are arranged a plurality of feed modules which are able to feed a wide variety of placement elements to the automatic placement machine during the placement process. In order to be able to ensure high placement accuracy, it is necessary that the feed modules can be positioned exactly on the automatic placement machines, for example by exact strips onto which the feed modules are placed. Moreover, it is desirable to be able to exchange the feed modules during the operation of the automatic placement machine, without the operation being able to be disrupted. Furthermore, disturbances in the positioning accuracy of the feed modules can occur as a result of placement elements accumulating on the bearings of the feed modules in the automatic placement machines and therefore preventing exact insertion of the feed modules.

### SUMMARY OF THE INVENTION

An object of the invention is to provide a precision bearing for feed modules of automatic placement machines which enables exact positioning of the feed modules on the automatic placement machine and also fault-free exchange of the feed modules during the operation of the automatic placement machine, without disturbances on account of deposited placement elements being able to occur.

The object is achieved by a precision bearing for feed modules of automatic placement machines, including a forced guidance portion to guide the feed modules in a manner exhibiting play displaceably on the automatic placement machine in a longitudinal direction of the feed modules, and a precision guidance portion to position the feed modules without play in an end region of the precision bearing.

The invention provides a precision bearing for feed modules of automatic placement machines which has a forced guidance portion and a precision guidance portion. In the forced guidance portion, the feed modules are guided in a manner exhibiting play and displaceably on the automatic placement machine in the longitudinal direction of the feed modules. In the precision guidance portion, the feed modules can be positioned without play in an end region of the precision bearing. In this case, the separation of forced guidance and precision guidance affords the advantage that an inexact forced guidance can also be designed with fault tolerance with respect to deposited placement elements and nevertheless restricts the freedom of movement of the feed module in the event of an exchange during the operation of the automatic placement machine to the extent that reliable operation of the automatic placement machine is ensured. Exact positioning of the feed module on the automatic placement machine is necessary only in an end region of the precision bearing in order to make available to the placement process a collection position for placement elements on the feed module with high accuracy.

The precision guidance portion can be designed in such a way that in the end region it takes up essentially all of the bearing forces. In this case, the play-exhibiting forced guidance portion can be completely relieved of the bearing forces, and transfer the bearing forces to the precision guidance portion, thereby avoiding mechanical redundancy.

Moreover, the end region of the precision bearing may be coupled to the forced guidance portion via a transition element. By way of example, the transition element may have a ramp-like design. This enables the feed module to be pushed into the end region of the precision bearing securely and without jolting.

The precision guidance portion may have bearing elements with inclined areas, which are each formed on the automatic placement machine or on the feed module and can be coupled to one another to receive the feed module. The effect that can be achieved by the use of inclined areas for the precision guidance portion is that a desired position is automatically assumed, without play, due to the weight force of the feed module.

By way of example, the inclined areas have an angle of inclination of 45°. The bearing elements can thus be of M-shaped or V-shaped design, i.e., have an M- or V-shaped cross section, and extend in the longitudinal direction of the feed modules.

The inclined areas may adjoin one another and are in this case formed in such a way that, in the coupled state of the bearing elements of the automatic placement machine and of the feed modules, a cavity in each case remains at the bottom between two inclined areas of the automatic placement machine. Deposited placement elements can accumulate in the cavity without the positioning accuracy of the precision guidance being impaired.

By way of example, in the forced guidance portion feed modules may each have at least one dovetail-like groove which tapers toward the bottom of the groove, and the forced guidance portion may include at least one sliding block whose form essentially corresponds to the groove, where the groove and the sliding block are formed in such a way that when the sliding block is arranged in the groove, a cavity remains at the bottom of the groove. The cavity at the bottom of the groove enables deposited placement elements to accumulate in the cavity without the function of the forced guidance being adversely affected. As a result of the tapering of the groove toward the bottom of the groove, deposited placement elements are deposited at the bottom of the groove and thus, when the sliding block has been pushed in, are located in the cavity. The grooves are preferably arranged on the automatic placement machine and the sliding block is in each case arranged on the feed modules. The sliding block may be provided with a wipe-off device by which objects, for example deposited placement elements, can be removed from the groove when it is pushed in and out of the groove.

In addition, the precision bearing may be provided with a precision hole in the vicinity of the end region and a positioning pin, which can engage essentially without play into the precision hole. By way of example, the precision hole may be formed in the automatic placement machine and the positioning pin may be formed on the feed module.

By virtue of the combination of precision guidance, precision hole and positioning pin, an even higher degree of accuracy for positioning the feed modules can be achieved in the end region of the precision bearing.

Moreover, by virtue of the invention's forced guidance in the longitudinal direction of the feed modules, the feed modules, when inserted into and withdrawn from the automatic placement machine, can execute movements essentially only in the longitudinal direction during the operation of the automatic placement machine. The risk of damage to the automatic placement machine and thus disruption of the operation of the automatic placement machine due to a collision between the feed modules and moving assemblies of the automatic placement machine is avoided.

### BRIEF DESCRIPTION OF THE DRAWINGS

The invention is explained in more detail with reference to the drawing, in which

FIG. 1 is a diagrammatic perspective view of components—arranged on an automatic placement machine—of a precision bearing according to a preferred embodiment of the invention;

FIG. 2 is a diagrammatic perspective view of the preferred embodiment of the invention;

FIG. 3 is a diagrammatic perspective view of components—arranged on a feed module—of the precision bearing according to the preferred embodiment;

FIG. 4 is a sectional view through part of the precision guidance according to the preferred embodiment;

FIG. 5 is a sectional view through part of the forced guidance according to the preferred embodiment of the invention; and

FIG. 6 is a perspective diagrammatic view of the forced guidance according to the preferred embodiment with feed module pushed into the end region.

### DETAILED DESCRIPTION OF THE PREFERRED EMBODIMENTS

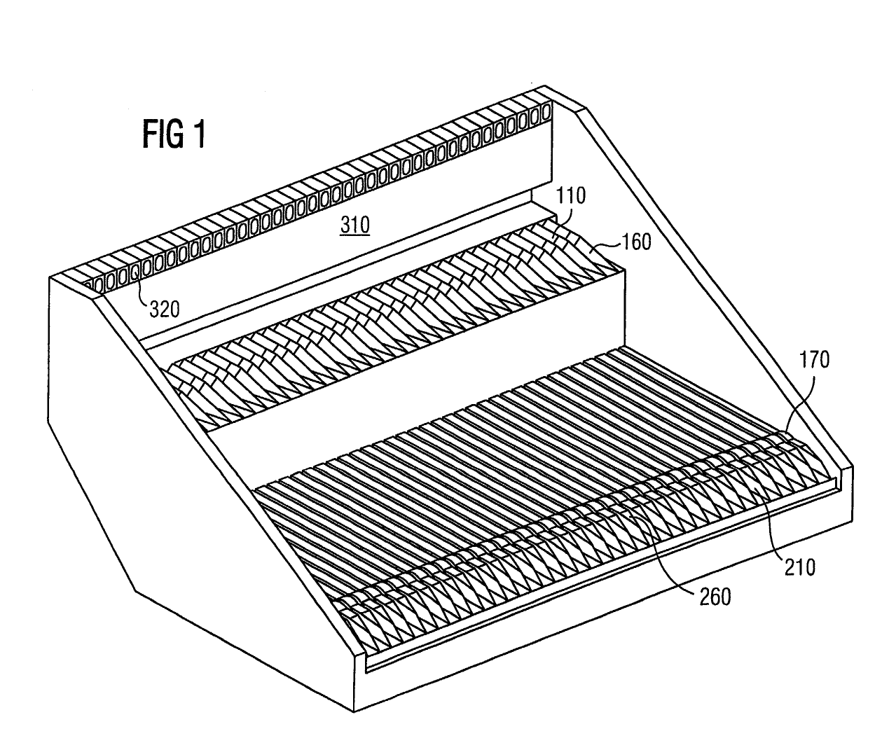

FIG. 1 reveals components of the preferred embodiment of the invention which are arranged on an automatic placement machine. As can be seen from FIG. 1, a plurality of dovetail-like grooves 210 are arranged parallel to one another and next to one another on the automatic placement machine. Each of the dovetail-like grooves 210 is provided with a ramp region 260, which facilitates the insertion of a sliding block fitted, for example on a feed module of an automatic placement machine. Bearing areas 170 are formed near the ramp region 260 of the dovetail-like grooves 210. The bearing areas 170 provide bearing locations for the feed modules positioned by the precision guidance according to the preferred embodiment of the invention. Provided in the vicinity of the end region E are bearing elements 110 having an M-shaped cross section, for example, and also ramp regions 160, which facilitate the insertion of a feed module into the end region E of the precision bearing according to the preferred embodiment. The bearing elements 110 form part of the precision guidance portion. Furthermore, adjoining the end region E, provision is made of stop areas 310 for feed modules and also precision slot holes 320.

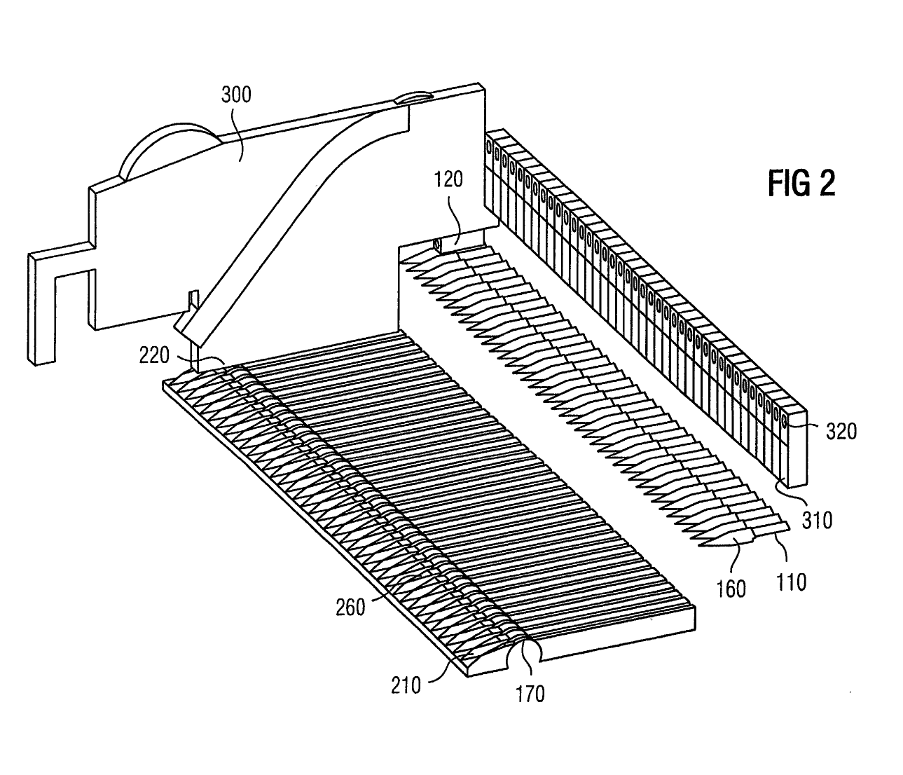

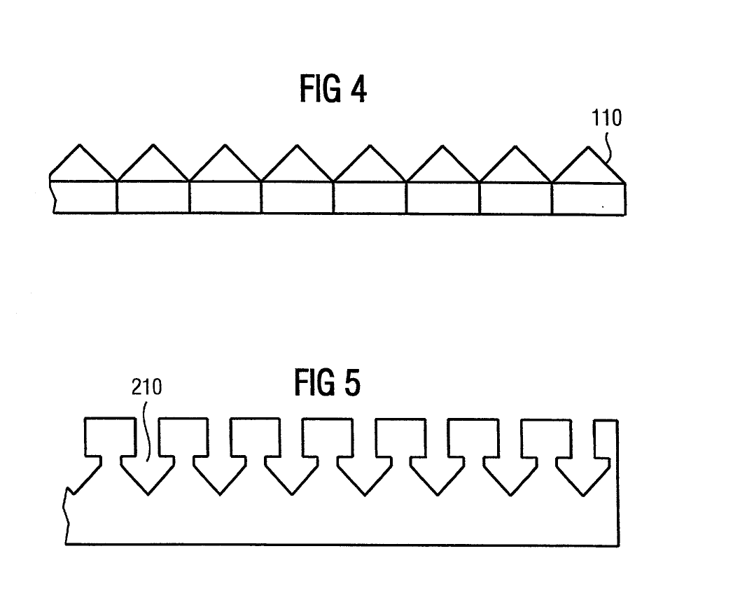

FIG. 2 shows a feed module 300 pushed into the precision bearing according to the preferred embodiment of the invention. In this case, a sliding block 220 fitted on the feed module 300 engages into the dovetail-like groove 210 on the automatic placement machine. The ramp region 260 in the initial region of the dovetail-like grooves 210 enables simple insertion of the feed module 300 into the groove 210. At its front end region, the feed module 300 is provided with a bearing element 120, which essentially corresponds to the form of one of the bearing elements 110 of the precision guidance portion. When the feed module 300 is pushed into the groove 210, the bearing element 120 fitted on the feed module 300 slides over the ramp region 260 into the bearing element 110 of the precision guidance portion, the bearing element being fitted on the automatic placement machine. The feed module 300, once it has been pushed in, can furthermore be engaged by a positioning pin 330 (evident from FIG. 4) inserted into one of a plurality of positional slot holes 320 which are provided in a manner adjoining a stop 310 for the feed module 300 on the automatic placement machine. By way of example, the positioning pin may be of cylindrical design and be fitted on the end area of the feed module which faces the precision slot hole 320 in the pushed-in state of the feed module.

In the pushed-in state, the feed module 300 merely rests by the bearing element 120 on the bearing element 110, and also by its rear end region on the bearing location 170. The forced guidance is not subjected to loading in the pushed-in state of the feed module 300.

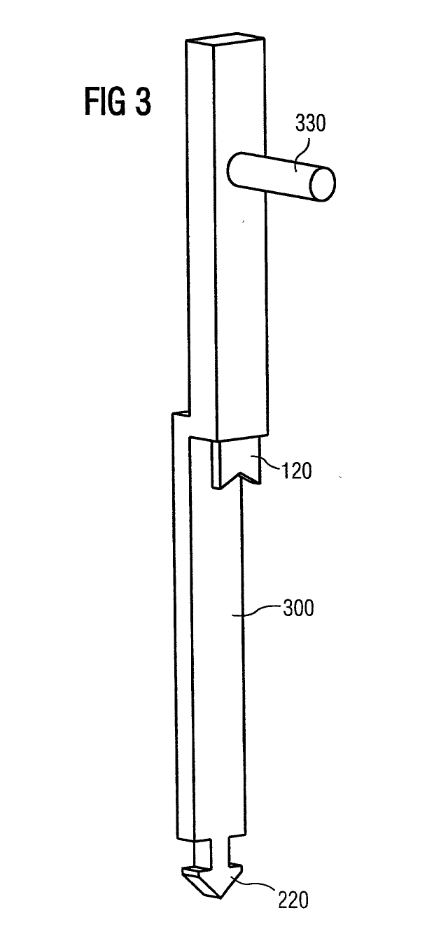

FIG. 3 reveals a detail view of the sliding block 220 which is arranged on the feed module 300 and essentially corresponds to the form of the groove, and also of the bearing element 120 which can engage into the bearing element 110 of the precision guidance portion. Corresponding cross sections of the bearing element 110 of the precision guidance portion and also of the dovetail-like grooves 210 of the forced guidance portion can be seen in FIGS. 4 and 5, respectively. The bearing element 120 arranged on the feed module 300 and the bearing element 110 of the precision guidance portion are in this case formed in such a way that, with the bearing element 120 engaging into the bearing element 110, a cavity remains at the bottom of the bearing element 110 at those locations at which the inclined areas of the bearing element 110 adjoin one another. Deposits, such as placement elements for example, can accumulate in the cavity without the positioning accuracy of the precision guidance being impaired.

Equally, the sliding block 220 and the dovetail-like groove 210 are formed in such a way that, when the sliding block 220 has been pushed into the groove 210, a cavity remains at the bottom of the respective groove, in which cavity deposits, such as placement elements for example, can accumulate without the mode of operation of the forced guidance being adversely affected.

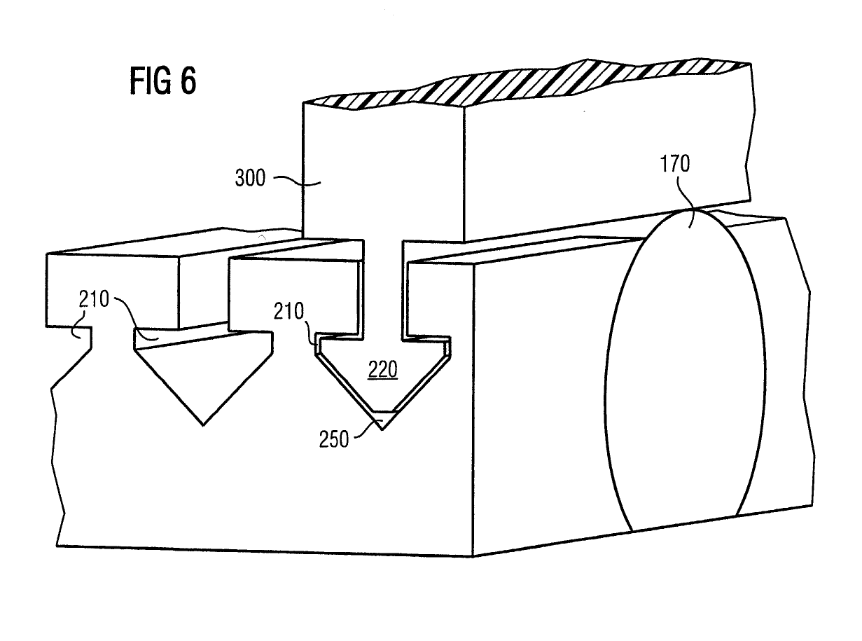

FIG. 6 reveals a detail of a feed module 300 in its end position in the precision bearing according to the preferred embodiment of the invention. In this case, the sliding block 220 fitted on the feed module 300 has been completely inserted into the groove 210. The sliding block 220 does not touch the groove 210. This is ensured by the feed module 300 being borne, in the end position, by the precision guidance with the bearing elements 120 and 110 (not shown in FIG. 6) and also by the bearing location 170. This makes it possible to avoid mechanical redundancy.

As can be seen in FIG. 6, a cavity 250 remains at the bottom of the groove 210, in which cavity deposits can accumulate without adversely affecting the mode of operation of the forced guidance.

A wipe-off device may be fitted on the sliding block 220, by which device placement elements deposited in the groove 210 can be removed during insertion and removal of the sliding block 220 from the groove 210.

What is claimed is:

1. A precision bearing for feed modules of automatic placement machines, comprising:
a forced guidance portion to guide the feed modules in a manner exhibiting play displaceably on the automatic placement machine in a longitudinal direction of the feed modules, and
a precision guidance portion to position the feed modules without play in an end region of the precision bearing.

2. The precision bearing as claimed in claim 1, wherein the precision guidance portion in the end region takes up essentially all of the bearing forces.

3. The precision bearing as claimed in claim 1, wherein the end region is coupled to the forced guidance portion via a transition element.

4. The precision bearing as claimed in claim 3, wherein the transition element is of ramp-like design.

5. The precision bearing as claimed in claim 1, wherein the precision guidance portion comprises bearing elements with inclined areas, each formed on one of the automatic placement machine and on the feed module and capable of being coupled to one another to receive the feed module.

6. The precision bearing as claimed in claim 5, wherein the inclined areas have an angle of inclination of 45°.

7. The precision bearing as claimed in claim 5, wherein the bearing elements have one of an M-shaped and a V-shaped design.

8. The precision bearing as claimed in claim 5, wherein the inclined areas are oriented in the longitudinal direction of the feed modules.

9. The precision bearing as claimed in claim 5, wherein the inclined areas adjoin one another and are formed with bearing elements of the automatic placement machine and of the feed modules coupled to one another and in each case a cavity remains at a low end between two inclined areas of the automatic placement machine.

10. The precision bearing as claimed in claim 1,
wherein the forced guidance portion has at least one dovetail-like groove which tapers toward the bottom of the groove,
wherein the forced guidance portion has at least one sliding block whose form essentially corresponds to the groove, and
wherein the groove and the sliding block are formed in such a way that when the sliding block is arranged in the groove, a cavity remains at the bottom of the groove.

11. The precision bearing as claimed in claim 10, wherein the at least one dovetail-like groove includes a plurality of grooves arranged on the automatic placement machine and the sliding block is in each case arranged on the feed modules.

12. The precision bearing as claimed in claim 10, wherein a wipe-off device is fitted on the sliding block, by which device objects can be removed from the groove.

13. The precision bearing as claimed in claim 1, further comprising:
a precision hole substantially in the end region; and
a positioning pin, which can engage essentially without play into the precision hole.

14. The precision bearing as claimed in claim 13, wherein the precision hole is formed in the automatic placement machine and the positioning pin is formed on the feed module.
